(19) United States
(12) Patent Application Publication
(10) Pub. No.: US 2019/0090504 A1
(43) Pub. Date: Mar. 28, 2019

(54) Soluble Coffee with Incorporation of Powdered Coffee and Methods for the Production Thereof

(71) Applicant: Industria Colombiana de Café S.A.S., Medellin (CO)

(72) Inventors: Luis Fernando Ríos Pérez, Medellín (CO); Viviana Londoño Zapata, Medellín (CO); Mauricio Naranjo Cano, Medellín (CO); Jorge Eduardo Pérez, Medellín (CO)

(21) Appl. No.: 16/060,948

(22) PCT Filed: Dec. 9, 2016
(86) PCT No.: PCT/IB2016/057513

§ 371 Date: Dec. 14, 2018

(30) Foreign Application Priority Data
Dec. 11, 2015 (CO) 15294516

(51) Int. Cl. A23F 5/40; A23F 5/38; A23F 5/34

(52) U.S. Cl. CPC A23F 5/405; A23F 5/34; A23F 5/38

(57) ABSTRACT

The invention relates to a process for obtaining soluble coffee with enhanced aroma, fragrance, and flavor compared to conventional soluble coffee, corresponding to the incorporation of pulverized coffee by continuous feeding during the drying operation of a coffee extract. Additionally, the invention also relates to the product obtained by said process, corresponding to instant coffee with pulverized coffee, preferably formulated with the incorporation of additives, powdered and/or also agglomerated.

The present invention relates to a process for obtaining soluble coffee with enhanced aroma, fragrance, and flavor compared to conventional soluble coffee.

In particular, the invention relates to a microdosing process of coffee pulverized by continuous feeding during the drying operation of a coffee extract. Additionally, the present invention also relates to the product obtained by said process, corresponding to instant coffee using pulverized coffee, preferably formulated with the use of additives, either powdered and/or also agglomerated.

### PRIOR ART

Percolation, or the extraction of soluble material, is the process of passing a flow of liquid, such as water at high temperature, using pressure between 8-12 bars, from the top of an extractor or storage tank of roasted and ground coffee, previously obtained by roasting green coffee, which represents the solid phase to be separated.

The combination of the water feed temperature and the pressure in the system produces the displacement of air particles and initiates the percolation process, generating an effluent liquid, in this case coffee extract, i.e., a mixture of water and soluble coffee solids, which is extracted until it reaches its maximum and/or desired concentration.

At this point, the entire effluent fraction of coffee extract is removed, which combines the aromatic portion with the most exhausted fraction. The solid remaining from the process is separated and disposed or used in other processes, and the liquid effluent or coffee extract is concentrated by means of evaporation and/or cryoconcentration, drying, and agglomeration processes.

An additional percolation method is known as split extraction, where the first fractions removed are the “heads,” which correspond to the first most aromatic portion, and then the “tails” are removed, which correspond to the most exhausted extract fraction. Both fractions may be mixed, or not, and then concentrated by means of evaporation and/or cryoconcentration, drying, and agglomeration processes.

Spray Drying (SD) is a process commonly used in the industry, for example, in the production of food and the production of pharmaceutical products and chemical products, among others.

In the food industry, specifically in the soluble or instant coffee manufacturing industry, the SD process is used to transform a liquid coffee extract into a fine powder of instant soluble coffee with specific physicochemical properties (such as color, density, humidity). The main purpose of the SD operation is food preservation.

In particular, spray drying is the dehydration of the liquid coffee extract, where a powder of soluble coffee solids is obtained as a result. The specific process consists of taking a coffee extract (a mixture of water and soluble coffee solids), with concentrations that can vary between 25 and 60° Brix and spraying it at high pressure (0-30 bar) through spouts or spray nozzles inside a drying chamber with downward flow. Said high pressure spraying produces a stream of small liquid droplets, whose size varies and can be modified according to the combination of extract concentration, spraying pressure, and the geometry of the spouts or spray nozzles used. This stream of droplets comes into direct contact with a stream of hot air at high temperature (90-130° C.), which, by means of heat transfer, produces the dehydration of the drop, resulting in a hemispherical and/or spherical particle of soluble coffee with a final moisture content (by weight) that is generally below 5%.

The process air used for drying is removed out to the environment from the drying chamber. Because the drying process produces particles of different sizes, some of the particles of smaller size and weight are entrained by said pneumatic transport system. Aiming to increase equipment efficiency and avoid product losses and pollution into the environment, the pneumatic transport system uses cyclones to separate the coffee particles from the air. These particles are removed at the bottom of the cyclone and then delivered to an airstream at room temperature that transports them back to the spray point (stream of fine material).

On the other hand, in the food industry, specifically in the coffee production industry, the roasted coffee grinding operation is also known, in which various particle sizes can be obtained to perform the application thereof, including roasted and ground coffee, with particle size between 300 and 600 μm, and pulverized coffee, which has a smaller particle size, approximately between 50 and 300 μm.

### BRIEF DESCRIPTION OF THE INVENTION

The present invention provides a process for obtaining soluble coffee with enhanced aroma, fragrance, and flavor in comparison to those of conventional soluble coffee.

After the usual operations of green coffee roasting, the coffee is extracted by percolating operations and concentrated in liquid phase. A stream of this phase is mixed with another portion of pulverized coffee to produce coffee powder with the incorporation of pulverized coffee through microdosing.

Therefore, the process of the present invention for producing soluble coffee involves microdosing of pulverized coffee during the drying operation of a coffee extract through the use of a system of stream mixtures in three phases: gas/liquid/solid, using high pressure (0-30 bar) as means of phase homogenization and integration. The scope of this invention includes the preparation of powdered and/or further agglomerated instant coffee.

Another aspect of the invention includes instant coffee incorporating pulverized coffee with the addition of coffee oils; solid, aqueous, and/or oily natural and/or artificial flavors; liquid or solid natural coffee aromas; functional ingredients such as antioxidants, minerals, fiber, omegas, vitamins, and spices; and other additives, previously in a preparation of coffee extract and/or in the microdosing process.

In a preferred embodiment of the invention, the liquid coffee extract is obtained from roasted and ground coffee, obtained from robusta and arabica green coffee varieties, as well as hybrids and/or mixtures thereof, and the pulverized and microdosed coffee is obtained from roasted and ground coffee, obtained from robusta and arabica green coffee varieties, as well as hybrids and/or mixtures thereof.

### BRIEF DESCRIPTION OF THE DRAWINGS

FIG. 1: shows a process diagram that illustrates a method of obtaining soluble coffee (P1), in which additives are added to the coffee extract and roasted ground coffee is incorporated directly during the air-dry process of the extract.

FIG. 2: shows a process diagram that illustrates a method of obtaining soluble coffee (P2), in which additives are added to the coffee extract to the coffee extract, with the incorporation of a portion of pulverized roasted coffee directly into the extract, prior to drying, and another portion of pulverized roasted coffee during the drying process.

FIG. 3: shows a process diagram that illustrates a method of obtaining soluble coffee P1, as in FIG. 1, which is subsequently agglomerated in order to obtain product P3, and where additives previously combined with the coffee extract are included.

FIG. 4: shows a process diagram illustrating a method of obtaining soluble coffee (P2), as in FIG. 2, which is agglomerated in order to obtain product P4, which is sprayed with other additives and then packed to obtain product P5.

FIG. 5: shows a process diagram illustrating a method of obtaining soluble coffee (P2), as in FIG. 2, with the incorporation of additives into the coffee extract, incorporating pulverized roasted coffee directly into the drying process and also previously into the coffee extract, where also an additional portion of pulverized roasted coffee is added during the agglomeration of product P2, in order to obtain product P6, which is sprayed with other additives and subsequently packed to obtain product P7.

FIG. 6: shows a dosing system for pulverized ground coffee.

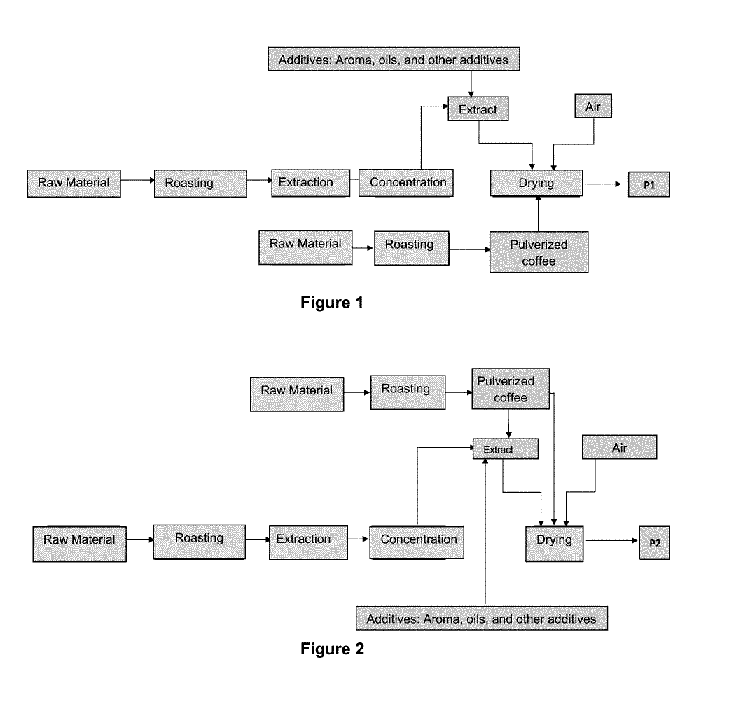

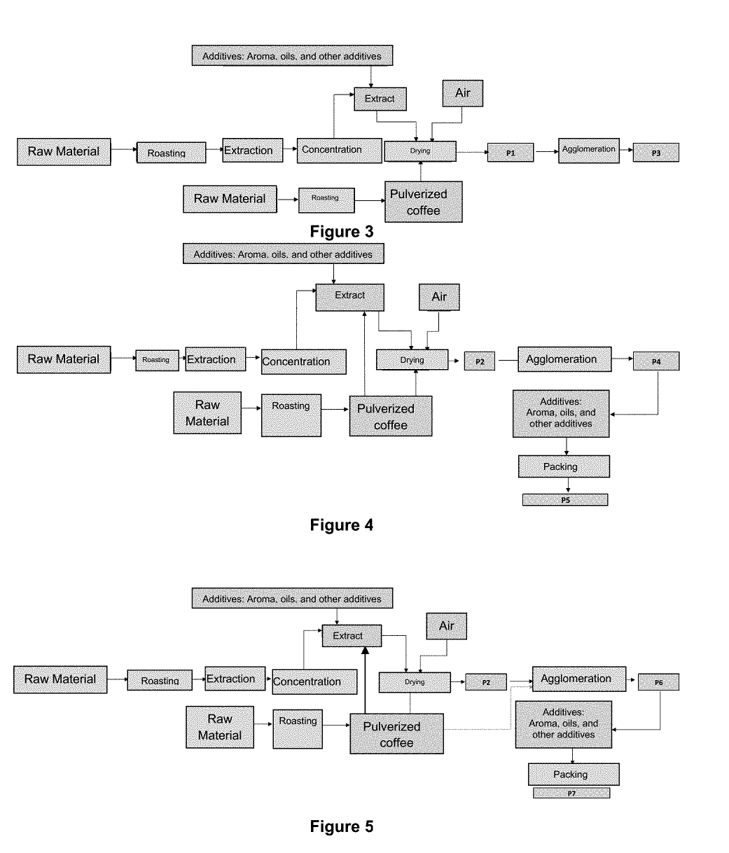

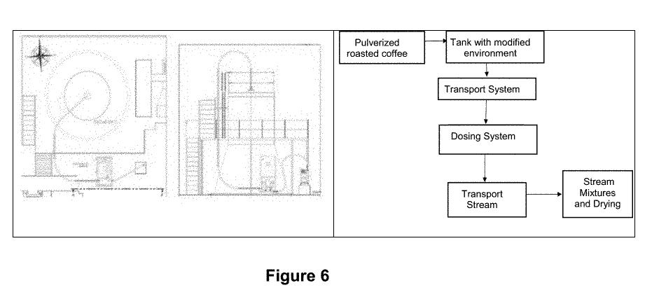

### DETAILED DESCRIPTION OF THE INVENTION

The process of the invention for the incorporation of pulverized coffee by means of microdosing during the drying operation of a coffee extract comprises feeding or dosing, in a controlled manner, a specific amount of pulverized coffee into a liquid stream of coffee extract, air, recirculation fine material, and pulverized coffee. Said feeding is carried out by means of a microdosing system, which controls the quantity of kilograms delivered to the transport air stream, according to the production rate (kg/h) of the dryer and the percentage of roasted ground coffee desired in the final product.

The microdosing operation is carried out from a pulverized coffee tank or container, which may include an environment modified with a gas and/or mixture of inert gases (to protect the pulverized roasted coffee from oxidation), which also comprises a weighing system and another system that delivers coffee to a dryer feeding stream.

The system that feeds pulverized roasted coffee to the dryer is responsible for transporting coffee from the tank or container to the air stream at a uniform flow rate (kg/h). In this sense, it produces several types of coffee holding different percentages of incorporation of pulverized roasted coffee (weight %), given that by varying the flow rate of the delivery system, pulverized roasted coffee will be added in greater or lesser proportion.

The pulverized roasted coffee is transported by the air stream to the spray point, wherein upon contact with the air stream, the droplets of the liquid stream of the coffee extract that come out of the spouts or spray nozzles of the dryer, and the stream of fine material coming from the recirculation of the cyclone system, adhere to each other to form a combined particle of soluble coffee and pulverized roasted coffee, which continues its journey through the drying chamber until it reaches the finished product output.

Finally, the agglomeration process of soluble coffee is the processing of combined particles of soluble coffee and pulverized coffee, obtained in the drying process in a uniform powder form, on which surface tension is created by means of humidification, contributing to the adhesion of several fine particles to larger ones, thus generating an amorphous product that is subsequently heated and cooled in a fluidized bed to produce its final finish.

In accordance with the foregoing, it is clear that a person of ordinary skill in the art can use the present invention to its fullest extent, using the foregoing description. Therefore, the following examples should be interpreted as merely illustrative.

### EXAMPLE 1

This process uses a storage tank (500 to 10,000 l) of coffee extract, made from arabica or robusta variety coffee, hybrids and/or mixtures of these varieties, with a concentration ranging between 25 and 50% kg of soluble solids, stored during (0-24 hours), which is spray dried.

It also uses pulverized coffee, with a particle size between (50 and 300 μm), stored in a tank with a modified environment to avoid coffee deterioration due to oxidation. The pulverized coffee is mixed with liquid coffee right at the outlet of the dryer's spray nozzles or spouts, where the system is neither solid nor liquid, but instead a mixture of three phases, which upon action by hot air entering through the upper part of the dryer, at an air temperature between (200 and 250° C.), is integrated into a single particle.

The coffee obtained (P1) has a humidity between 0 and 5%, more specifically between 0 and 3.0%; the density of the obtained product is between 100 and 600 g/I, more specifically between 150 and 450 g/l, the color of the obtained product is between 10 and 50 luminosity (L*), more specifically between 15 and 35 L*; and the % of pulverized roasted coffee ranges between 4 and 20%, more specifically between 6 and 12%.

### EXAMPLE 2

The product of Example 1 is agglomerated by means of steam spraying the particles of soluble coffee in order to group them, seeking to obtain product P3. Prior to packaging in flexible glass, cans, and PET containers, solid, aqueous, and/or oily natural and/or artificial flavors, liquid or solid natural coffee aromas, and functional ingredients such as antioxidants, minerals, fibers, omegas, vitamins, and spices are added to bring out its features by means of direct application in the coffee extract or by spraying.

### EXAMPLE 3

The product of the Example 1 is agglomerated as described in Example 2, but the pulverized coffee is added at the moment when steam spraing is used for the agglomeration process, thus generating a mixture of pulverized coffee, steam, and soluble coffee particles. Subsequently, the product is packaged in flexible glass, cans, and PET containers, and solid, aqueous, and/or oily natural and/or artificial flavors, liquid or solid natural coffee aromas and functional ingredients such as antioxidants, minerals, fibers, omegas, vitamins, and spices are added to bring out its features. The final product is packed under a modified environment (with a lower oxygen percentage in the package ranging between 0 and 15% for the final product preservation).

### EXAMPLE 4

This process uses a storage tank (500 to 10,000 l) filled with coffee extract made from arabica or robusta variety coffee, hybrids and/or mixtures of these varieties, with a concentration ranging between (10 and 60% kg) of soluble solids, stored during (0-48 hours), which is then spray dried.

It also uses pulverized coffee, with a particle size between (45 and 350 μm), stored in a tank having a modified environment in order to avoid coffee deterioration due to oxidation. The pulverized coffee is mixed with liquid coffee right at the outlet of the dryer's spray nozzles or spouts, where the system is neither solid nor liquid, but instead a mixture of three phases, which upon action by hot air entering through the upper part of the dryer, at an air temperature between (190 and 240° C.), is integrated into a single particle.

The coffee obtained (P1) has a humidity between 0 and 5%, more specifically between 0 and 3.0%; the density of the obtained product is between 100 and 600 g/l, more specifically between 150 and 450 g/l, the color of the obtained product is between 10 and 50 (L*), more specifically between 15 and 35 L*; and the % of pulverized roasted coffee ranges between 5 and 50%, more specifically between 6 and 12%.

### EXAMPLE 5

This process uses a storage tank (500 to 10,000 l) filled with coffee extract made from arabica or robusta variety coffee, hybrids and/or mixtures of these varieties, with a concentration ranging between (25 and 50% kg) of soluble solids, stored during (0-24 hours), which is then spray dried.

It also uses pulverized coffee, with a particle size between (50 and 300 μm), stored in a tank having a modified environment in order to avoid coffee deterioration due to oxidation. The pulverized coffee is mixed with liquid coffee right at the outlet of the dryer's spray nozzles or spouts, where the system is neither solid nor liquid, but instead a mixture of three phases, which upon action by hot air entering through the upper part of the dryer, at an air temperature between (200 and 250° C.), is integrated into a single particle.

The coffee obtained (P1) has a humidity between 2 and 3%, more specifically between 0 and 3.0%; the density of the obtained product is between 300 and 400 g/l, more specifically between 150 and 450 g/l, the color of the obtained product is between 20 and 27 (L*), more specifically between 15 and 35 L*; and the % of pulverized roasted coffee ranges between 4 and 12%, more specifically between 6 and 12%.

### EXAMPLE 6

Aromas, oils, and/or other additives are added to the product of Example 1 to bring out its features by means of direct application in the coffee extract or spraying. The final product shows final conditions of humidity between 4 and 5%, color between 30 and 40 L, density between 150 and 300 g/l and a percentage of pulverized roasted coffee in a range between 15 and 20%.

1. A method for preparing soluble coffee incorporating pulverized coffee, comprising the steps of:
providing coffee extract;
providing pulverized coffee;
subjecting the coffee extract to a drying process;
incorporating the pulverized coffee into the coffee extract during the drying process;
recovering a soluble coffee product that incorporates the pulverized coffee.

2. The method for preparing soluble coffee incorporating pulverized coffee according to claim 1, wherein the drying process is carried out by means of spraying.

3. The method for preparing soluble coffee incorporating pulverized coffee according to claim 2, wherein the incorporation is carried out at the outlet of the spouts or spray nozzles of the dryer.

4. The method for preparing soluble coffee incorporating pulverized coffee according to claim 1, wherein a portion of pulverized coffee is mixed with the coffee extract before drying and the remaining portion of pulverized coffee is incorporated during the drying process.

5. The method for preparing soluble coffee incorporating pulverized coffee according to claim 1, wherein the incorporation of pulverized coffee is carried out by means of microdosing.

6. The method for preparing soluble coffee incorporating pulverized coffee according to claim 1, wherein additives are added to the coffee extract before the drying process.

7. The method for preparing soluble coffee incorporating pulverized coffee according to claim 1, wherein the soluble coffee product is further agglomerated.

8. The method for preparing soluble coffee incorporating pulverized coffee according to claim 7, wherein a portion of pulverized coffee is added during the agglomeration process.

9. The method for preparing soluble coffee incorporating pulverized coffee according to claim 7, wherein the agglomerated product is combined with additives.

10. The method for preparing soluble coffee incorporating pulverized coffee according to claim 7, wherein agglomeration is carried out by steam spraying the soluble coffee particles.

11. The method for preparing soluble coffee incorporating pulverized coffee according to claim 6, wherein addition of additives is carried out by spraying.

12. A soluble coffee product incorporating pulverized coffee, manufactured by the method of claim 1.

13. A soluble coffee product incorporating pulverized coffee containing additives, manufactured by the method of claim 6.

14. (canceled)

15. The agglomerated soluble coffee product incorporating pulverized coffee according to claim 8.

16. (canceled)

17. The agglomerated soluble coffee product incorporating pulverized coffee according to claim 13, wherein the additives are selected from the group comprising coffee oils, solid, aqueous, and/or oily natural and/or artificial flavors, liquid or solid natural coffee aromas, antioxidants, minerals, fibers, omegas, vitamins, and spices.

18. The agglomerated soluble coffee product incorporating pulverized coffee according to claim 12, wherein the coffee is selected from the group of robusta and arabica green coffee varieties, as well as hybrids and/or mixtures thereof.
